(19) United States
(12) Patent Application Publication
(10) Pub. No.: US 2008/0142441 A1
(43) Pub. Date: Jun. 19, 2008

(54) Methods for Degassing Hydrophobic Liquids and Emulsions Formed Therefrom

(76) Inventor: Richard Mark Pashley, Cook (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/794,214

(22) PCT Filed: Jun. 22, 2005
(86) PCT No.: PCT/AU05/01971

§ 371 Date: Nov. 9, 2007

(30) Foreign Application Priority Data
Dec. 22, 2004 (AU) 2004907241

(51) Int. Cl. B01D 19/00

(52) U.S. Cl. 210/640

(57) ABSTRACT

The present invention relates to a method of degassing a hydrophobic liquid containing dissolved gas, comprising passing the hydrophobic liquid along one side of a porous hydrophobic membrane and simultaneously passing a degassed aqueous liquid along the other side of the membrane, such that at least a portion of the gas dissolved in the hydrophobic liquid is transferred to the aqueous liquid. The invention also relates to methods of preparing emulsions using the prepared degassed hydrophobic liquid in combination with an aqueous liquid. The emulsions thus prepared are substantially free of emulsifiers, surfactants or stabilisers.

### FIELD OF THE INVENTION

The present invention relates generally to methods of degassing hydrophobic liquid phases using porous hydrophobic membranes. The invention also relates to methods of preparing emulsions of a hydrophobic liquid and an aqueous liquid. Advantageously, emulsions prepared thus are substantially free of emulsifiers, surfactants or stabilisers. The invention further relates to emulsions so prepared.

### BACKGROUND OF THE INVENTION

The reference to any prior art in this specification is not, and should not be taken as, an acknowledgment or any form of suggestion that that prior art forms part of the common general knowledge in Australia.

The contents of the references cited in this document are taken to be incorporated herein, in their entirety for all purposes.

The removal of dissolved gases (degassing), such as O₂, N₂, and CO₂ from aqueous and non-aqueous liquids finds multitudinous applications in chemical, pharmaceutical and engineering industries. For example, oxygen removal is essential for oxygen sensitive chemical reactions, such as radical-based reactions, and aids long term storage of, pharmaceutical formulations by preventing oxidative degradation. More recently, degassed solvents have been found to be very useful in the formation of stable emulsions (such as oil-in-water emulsions) and particulate dispersions of hydrophobic materials in aqueous phases, without the need for added emulsifiers, surfactants or stabilizers (U.S. patent application Ser. No. 10/703,094, WO 2005/044884, and WO 2005/044229).

A number of methods are currently used to degas liquid phases. One is the freeze-pump-thaw method whereby the liquid phase is frozen in liquid nitrogen and out-gassed by a vacuum pump. Following removal of the gas, the frozen liquid is allowed to thaw and remaining dissolved gases are drawn into the space above the liquid. The cycle may be repeated several times. Alternatively, partial degassing using sonication under slight vacuum can be employed. Purging, where an active gas, such as oxygen, is replaced by an inert one, e.g. nitrogen, may also be used where the absence of a particular gas is desirable. In more recent years, microporous membranes have increasingly been used to degas aqueous liquid phases. The technology has now moved from small laboratory scale devices to large scale industrial devices suitable for water treatment systems operating at hundreds to thousands of litres per minute. Microporous membranes allow a gaseous phase and a liquid phase to come into contact with one another for the purpose of mass (gas) transfer without dispersing one phase into another. Typically these can be used to remove gases dissolved in water. These processes utilise the phenomenon of surface tension and the resulting pressure difference which occurs across a curved liquid interface when a liquid makes contact with a surface.

Where a liquid having a surface tension γ makes a contact angle θ with a capillary tube or pore having a radius r, the pressure difference, ΔP, also known as the Laplace pressure, is calculated by:

$$Δ P = \frac{2 γ cos θ}{r}$$

This is the pressure required to force the liquid into the pore.

For a fully or partially wetting situation, say, where the contact angle is <90°, the liquid will spontaneously wet the pore and will flow through under a low pressure gradient. In contrast, where the contact angle is greater than about 90°, say in the instance of water and a hydrophobic pore, then the liquid would only be forced into the pore under substantial pressure. Thus, hydrophobic porous membranes have small pores through which water cannot pass without the application of a substantial pressure. The membrane acts essentially as a support between a liquid and gaseous phase which allows them to interface at the pore.

Henry's law states that the amount of gas that will dissolve into water at equilibrium is proportional to its partial pressure in the vapour phase in contact with the water. Thus, if the partial pressure of the gas in contact with the water (having initial dissolved gas, such as O₂, N₂ and CO₂, concentrations corresponding to atmospheric pressure values) is reduced, for example with a vacuum or an inert sweep gas on the other side of the membrane, then dissolved gases will be drawn from the water and travel across the membrane, thereby degassing the water.

By virtue of water's high surface tension (73 mJm⁻²) and by employing a membrane with a low surface tension, for example Teflon®, which has a surface tension of approximately 18 mJm⁻², the resulting interfacial tension is also high, giving a contact angle of 110°. Dissolved gases can be removed from an aqueous stream by having aqueous fluid flow on one side of a membrane and a sweep gas and/or a vacuum applied to the other side. Adjusting the partial pressure of the gas in contact with the water can allow gases to be selectively removed. Under 1 atm and at 25° C., water will contain approximately 8.5 ppm dissolved oxygen. In this manner, residual levels of oxygen can be reduced to approximately 1 ppb, which corresponds to a degassing level of about 99.98%

Given the efficiency of microporous membranes and their consequent applicability to large scale treatments, and the advantages of using degassed hydrophobic liquids in certain applications, such as the formation of stable emulsions being substantially free of surfactants and stabilizers, it would be desirable to be able to degas hydrophobic liquids using porous membranes.

However, hydrophobic liquids such as hydrocarbons and fluorocarbons have low surface tension values close to those of the hydrophobic membranes used to degas water. The resulting contact angle is therefore low and the hydrophobic liquid will wet the pores, particularly in the case where a vacuum is applied to the other side of the membrane, and pass through the membrane. Thus, the methods currently used to degas water are not suitable for degassing hydrophobic liquids.

### SUMMARY OF THE INVENTION

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

It has now been found that a hydrophobic liquid which contains gas dissolved therein can be degassed using a porous hydrophobic membrane by passing a substantially degassed aqueous liquid (e.g. water) along one side of the membrane and the hydrophobic liquid containing dissolved gas on the other side such that the two liquids are in contact at the membrane yet do not mix. Whilst a differential pressure is maintained, in practice approximately the Laplace pressure, the hydrophobic liquid will not pass through the membrane into the aqueous liquid and the aqueous liquid will not flow into the hydrophobic liquid, i.e. the two liquids will not disperse in one another. However, through the liquid-liquid interface at the membrane, dissolved gases in the hydrophobic liquid will flow out into the degassed water until equilibrium is achieved.

Accordingly, in a first aspect, the present invention provides a method for degassing a hydrophobic liquid containing dissolved gas, comprising passing the hydrophobic liquid along one side of a porous hydrophobic membrane and simultaneously passing a degassed aqueous liquid along the other side of the membrane, such that at least a portion of the gas dissolved in the hydrophobic liquid is transferred to the aqueous liquid.

In a preferred embodiment, the aqueous liquid and the hydrophobic liquid flow in opposite directions.

In another form, the porous hydrophobic membrane is made of Teflon or polypropylene or polymethylpentene.

In a particularly preferred embodiment, at least 80-90% of the gas dissolved in the hydrophobic phase its transferred to the aqueous phase, more preferably at least about 99%. In another preferred form of the invention, the resulting degassed hydrophobic liquid contains no more than about 10-100 ppb of oxygen. In another preferred embodiment, the degassed aqueous phase has been degassed to remove at least 80-90% of the gas dissolved therein, more preferably at least about 99%. The degassed aqueous phase preferably contains no more than about 10-100 ppb of oxygen.

In a further aspect, the invention provides a method for preparing an emulsion of a hydrophobic liquid and an aqueous liquid comprising:
(i) degassing a hydrophobic liquid containing dissolved gas, comprising passing the hydrophobic liquid along one side of a porous hydrophobic membrane and simultaneously passing a degassed aqueous liquid along the other side of the membrane, such that at least a portion of the gas dissolved in the hydrophobic liquid is transferred to the aqueous liquid;
(ii) combining said degassed hydrophobic liquid with a degassed aqueous liquid to form an emulsion.

Preferably the emulsion is formed by shaking or agitation of the combined degassed hydrophobic and aqueous liquids and advantageously requires no stabilizers, surfactants or dispersants (emulsifiers).

### BRIEF DESCRIPTION OF THE FIGURES

FIG. 1 depicts a schematic diagram of the use of counter-flow degassed water to degas hydrophobic liquids using hollow fibre membranes.

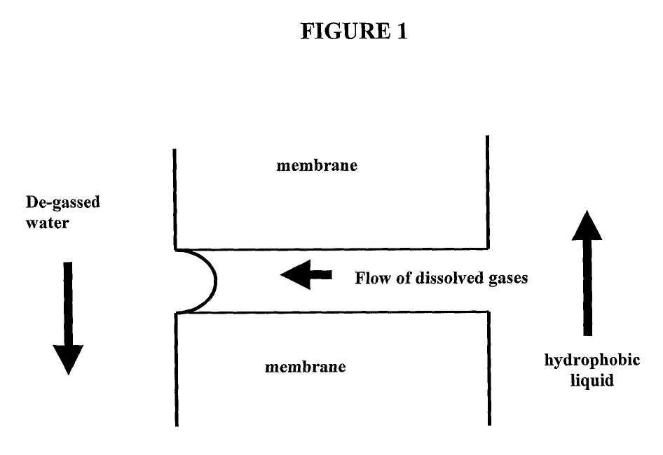

FIG. 2 depicts a schematic diagram of a hollow-fibre cartridge used to degas hydrophobic liquid by the counter-flow process.

FIG. 3 graphically depicts the Laplace pressure for water/dodecane and water/tetrachloroethylene as a function of pore size (r=0.01-1 μm) in a Teflon® membrane.

FIG. 4 graphically depicts the turbidity (measured over time) of emulsions prepared by degassing in accordance with the invention, degassing by the freeze-pump-thaw method and a gassed blank.

### DETAILED DESCRIPTION OF THE INVENTION

The singular forms “a”, “an” and “the” include the plural aspects unless the context indicates otherwise. For example, reference to removal of a dissolved gas includes a single gas, e.g. O₂, N₂ or CO₂ as well as two or more gases as appropriate.

The invention provides a means for degassing a hydrophobic liquid by passing the hydrophobic liquid along and in contact with one surface of a porous hydrophobic membrane and simultaneously passing a degassed aqueous liquid along and in contact with the opposite surface of the membrane. The two liquids are in contact at the membrane such that gases dissolved in the hydrophobic phase are transferred into the aqueous phase but their mixing is prevented by a pressure differential across the liquid-liquid interface.

As used herein a “hydrophobic liquid” is one which is essentially immiscible with or insoluble in water, i.e. has a water solubility of less than 0.1%, preferably 0.01%. A degree of hydrophobicity can be estimated by applying the Young's wetting equation to a theoretical liquid/liquid drop profile. By this means a theoretical water droplet contact angle on the oil surface can be calculated. A liquid which has a theoretical water droplet angle of at least about 80°, more preferably at least about 90° may for the present purposes be taken to be hydrophobic. For example dodecane has a theoretical water contact angle of 112°, octane 113°, perfluorohexane 111°, benzene 95° and carbon tetrachloride 105°.

One group of hydrophobic liquids contemplated herein are hydrocarbons, particularly those having at least 8, preferably greater than 8 carbon atoms. Hydrocarbons include saturated and unsaturated hydrocarbons, e.g. alkanes, alkenes, alkynes and aromatic hydrocarbons which may be straight, branched and/or cyclic. Preferred examples thereof include C₉-C₂₀ alkanes, alkenes and alkynes, such as the alkanes nonane, decane, undecane, dodecane, tridecane, tetradecane, and pentadecane; and benzene and styrene.

The invention also contemplates halogenated hydrocarbons also referred to herein as halocarbons, where one or more hydrogen atoms of a hydrocarbon are replace by one or more of the same or different halogens (i.e. F, Cl, Br and I). Halogenated hydrocarbons include those from C₁-C₂₀, for example carbon tetrachloride and tetrachloroethylene.

Fluoronated hydrocarbons, e.g. perfluorocarbons, are another such group contemplated by the invention, and are compounds where one or more hydrogen atoms of a hydrocarbon are replaced by a fluorine atom. A perfluorocarbon is taken to be a fluorocarbon where at least about 50%, more preferably at least about 60%, up to 100%, of the hydrogen atoms of a hydrocarbon are replaced by fluorine atoms. Some preferred fluorocarbons include C₁-C₂₀ fluorocarbons, for example C₄-C₁₂.

Perfluorocarbons have a very low surface tension against air, while having a very high interfacial tension against water, this gives them a very high theoretical water droplet contact angle. This high water contact angle means that they are very hydrophobic (see the following table) making them perfect candidates for the degassing process. Perflubron is the generic name for perfluorooctyl bromide (PFOB), a perfluorocarbon drug delivery oil commonly used in the pharmaceutical industry and is also contemplated herein.

### Physical Properties:

| | C₇F₁₆ | C₆F₁₄ | C₈F₁₈ | Perflubron |
|---|---|---|---|---|
| Interfacial tension | 39.7 | 38 | 42 | 47 |
| (mN/m) | | | | |
| Surface tension | 12.85 | 11.91 | 14.00 | 18 |
| (mN/m) | | | | |
| Density (g/ml) | 1.75 | 1.669 | 1.73 | 1.93 |
| Theoretical | 112° | 111° | 113° | 113° |
| contact angle | | | | |

Perfluorocarbons are capable of dissolving and carrying large amounts of physiologically essential gases, such as O₂ and N₂. They are therefore particularly useful either as a pharmaceutically active agent in themselves, to coat alveoli and facilitate oxygen transfer in the treatment of injured, immature/premature, diseased or otherwise non-fully functioning lungs, and/or as carriers for bronchodilators, antibiotics, etc, in the treatment of various lung disorders such as respiratory distress syndrome, asthma, emphysema and infections. Additionally, by taking advantage of its gas transport capacity, an aqueous emulsion of PFOB (droplets comprising a PFOB core, surrounded by lecithin) is currently under development for use as a blood substitute during surgery. Accordingly, aqueous dispersions or emulsions of perfluorocarbons are of particular interest. Other hydrocarbon liquids include oils used in the cosmetic, pharmaceutical and food industries, such as straight, branched or cyclic silicone oils (e.g. dimethicone, cyclomethicone), lavender oil, eucalyptus oil, tea tree oil, soybean oil, castor oil, rapseed oil and cottonseed oil, as well as oil or liquid forms of pharmaceutically or biologically active agents, e.g. propofol, such as described in WO 2005/044229. Other hydrocarbon liquids may include monomers for use in polymerization processes, such as styrene and perfluorostyrene, octafluorostyrene, octafluoropentyl acrylate and hexafluorobutyl methacrylate.

A “hydrophobic liquid” may also be a mixture of miscible hydrophobic components, such as a hydrophobic solid or liquid dissolved in another hydrophobic phase. These may suitably include hydrophobic pharmaceutically or biologically active agents in an appropriate carrier, such as described above, or monomers, for polymerization processes, dissolved in an appropriate solvent.

An “aqueous liquid” includes pure or essentially pure water as well as mixtures of water and water miscible or soluble components, (e.g., salts). An example of such a mixture is sea water. It will be understood that the nature and amount of water soluble components or solvents in the aqueous liquid will be such that the contact wetting angle against the hydrophobic pore surface is not altered to the extent that the aqueous liquid can wet and enter the pore.

The terms “liquid” and “fluid” as used herein may be used interchangeably.

An “emulsion” is a suspension or dispersion of droplets of one immiscible liquid in another. The emulsion may be an aqueous phase suspended or dispersed in a hydrophobic phase (also known as a “water-in-oil” emulsion) or a hydrophobic phase suspended or dispersed in a liquid phase (also known as an “oil-in-water” emulsion).

As used herein, the term “degassing”, or variations such as “degassed” or “degas” refers to the removal of at least a proportion of the gas or gases dissolved in an aqueous or hydrophobic liquid, as appropriate. For example, water at equilibrium with the air at 25° C. and at 1 atm contains approximately 8.5 ppm O₂, and 14.5 ppm N₂. The presence or absence of dissolved gases is commonly measured by determining the concentration or amount of O₂ present in the liquid. It will be appreciated that if the aqueous liquid is substantially free of all gases, then all gases in the hydrophobic liquid will transfer and a measure of the concentration of O₂ remaining in a liquid is a reflection of the total gas transfer. However, if the aqueous phase is degassed of O₂ but saturated with another gas, say, N₂, then the hydrophobic liquid will be degassed of O₂ but not N₂. Whilst reference to degassing preferably refers to non-selective degassing, i.e. removal of all types of gasses, it will be appreciated that the degassing methods may also apply to selective degassing.

Preferably at least 80% of dissolved gas is removed from a liquid, more preferably at least 90% or 95%. Most preferably at least 97% or 99% of dissolved gases are removed and even more preferably about 99.9% are removed. A liquid substantially free of dissolved gases is one where at least 80% have been removed, and most preferably at least 99%. In a preferred form, the liquid contains only about 10-100 ppb O₂, more preferably about 1-10 ppb. A degassed aqueous liquid which is passed along the other side of the membrane to the hydrophobic liquid is one which preferably has had at least 80% of the dissolved gases removed but at least contains a lesser concentration of dissolved gas than the hydrophobic liquid so that equilibrium drives the transfer of the dissolved gas to the aqueous phase.

The hydrophobic porous membranes contemplated by the invention may be from any suitable material (a single component, i.e. homogenous membrane, or a mixture of components, i.e. non-homogenous membrane) which is sufficiently hydrophobic, i.e. has a water droplet contact angle in air of at least about 80°, more preferably at least about 90°. Particularly preferred hydrophobic materials give a water droplet contact angle of 100-110°, or above. Particularly preferred membranes are formed from polytetrafluoroethylene—PTFE (also known as Teflon®), polypropylene or polymethylpentene, most preferably PTFE, or polypropylene.

In a preferred form of the invention, hydrocarbon liquids are degassed using PTFE membranes and fluorocarbon liquids are degassed using polypropylene membranes.

From the Laplace equation it is apparent that the radius of the pores in the membrane will affect the pressure difference and therefore, to an extent dictate whether the membrane effectively prevents dispersion of the aqueous and hydrophobic liquids. Depending on the nature of the membrane and the hydrophobic liquid, the pores may range in radius from about 0.1 mm, down to submicron level, e.g. about 0.1 to about 0.0 μm. For efficiency, it is preferred that the pore size is less than 100 μm, preferably less than 10 m and more preferably about 1 μm or less, for example in the range of about 0.5-0.1 m and down to about 0.05-0.03 μm.

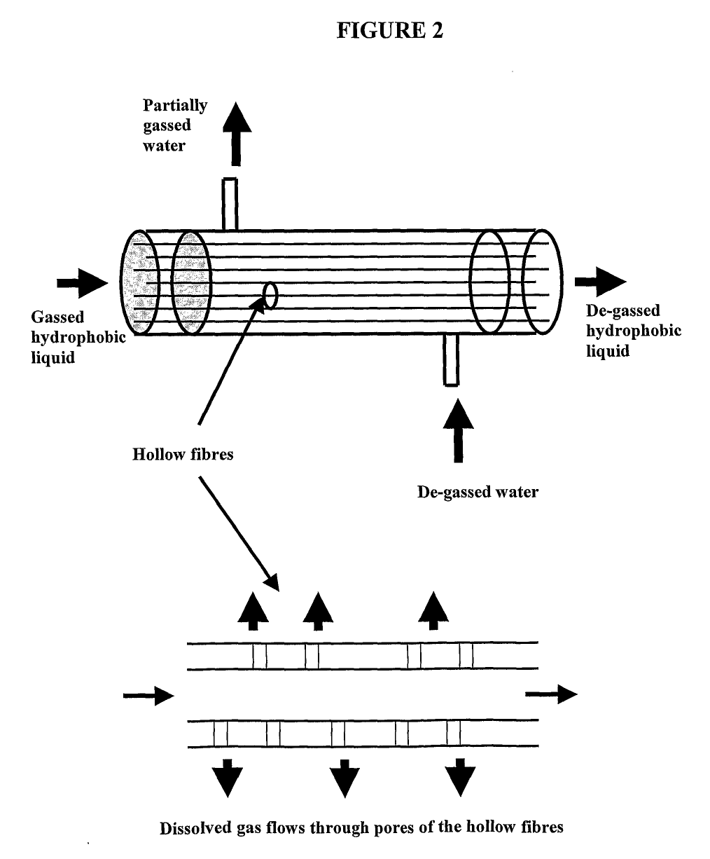

Successful and efficient membrane-mediated degassing of a liquid requires a very high surface area of contact per unit volume of fluid. This can be achieved with hollow fibre filter or membrane units (also known as contactors). Typically, these comprise the membrane in the form of hollow fibre bundles housed in a casius or shell. The aqueous liquid may be used as the outer fluid while the hydrophobic liquid flows inside the fibres. A schematic example is depicted in FIG. 2. Commercial membrane contactors, including hollow fibre filters and hollow-fibre-contained-liquid-membrane contactors, are readily available and may be employed in the method of the invention.

For efficiency, the degassed aqueous liquid and gassed hydrophobic liquid preferably flow in parallel and opposite directions, to produce a counter current gas exchange process.

It will be recognised that in order to obtain maximum degassing it may be necessary to perform the degassing process more than once. A single contactor may be used and the progressively degassed hydrophobic liquid is passed or cycled through or alternatively a plurality of membrane contactors may be connected in series, for example, 2, 3 or 4 units. Optionally, a membrane contactor can also be used to degas the aqueous liquid.

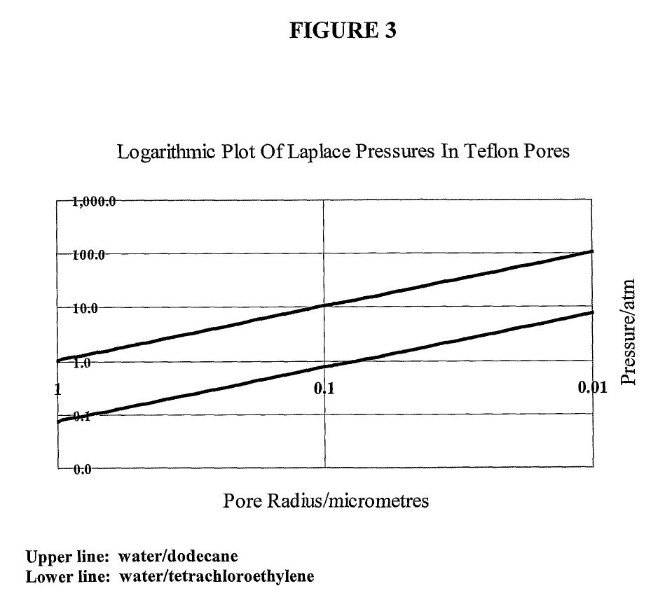

By determining surface tension and the contact angles for a hydrophobic liquid on a particular membrane surface, using the equations and methods described herein and known in the art, the skilled person can readily determine suitable membrane properties, including pore sizes. Similarly, the differential pressure required for a particular hydrophobic liquid to be retained by the water, i.e. to prevent mixing of the two liquids, can also be readily calculated. Often this is pressure can be adequately applied by selecting an appropriate flow rate of the liquid. Alternatively, an appropriate pump pressure can be applied. By way of example, Laplace pressures calculated for water/dodecane and water/tetrachloroethane mixtures in Teflon pores with a radius from 0.01-1 μm are depicted in FIG. 3.

The degassed hydrophobic liquids obtained by the method of the invention may advantageously be used to prepare emulsions which require no additional dispersants surfactants or stabilizers for their formation or stability. As described in U.S. patent application Ser. No. 10/703,094, WO 2005/044884, and WO 2005/044229, a mixture of a degassed aqueous phase and a degassed immiscible hydrophobic phase readily forms a stable emulsion without the addition of dispersants surfactants or stabilizers. Another aspect of the invention thus provides a method for a preparing an emulsion of a hydrophobic liquid and an aqueous liquid comprising combining a hydrophobic liquid, which has been degassed in accordance with the present invention, with a degassed aqueous liquid and forming an emulsion, preferably by vigorous mixing of, shaking or agitating the mixture.

Hydrophobic monomers which are liquid at room temperature can be readily degassed using the counter-flow technique, providing that their viscosity is not too much greater than water. Hydrophobic (oil soluble) radical initiators, such as azobisisobutyronitrile and benzoin ethers can be dissolved in the monomer or mixture of monomers to be degassed. Thus, these oils can be polymerized once dispersed in water in degassed mixtures, without the need for surfactant stabilizers. Monomers suitable for such processes include pentafluorostyrene, styrene, octafluorostyrene, octafluoropentyl acrylate and hexafluorobutyl methacrylate.

In a further embodiment, the present invention also lends itself to in situ formation of an emulsion. As described above, during the degassing process a pressure differential across the liquid-liquid interface is necessary to prevent one liquid from dispersing into the other. However, once degassing is completed to the desired level, a pressure differential could be applied to allow the hydrophobic liquid to pass through the membrane and disperse into the degassed aqueous phase, and thus form an emulsion. Suitably this could be achieved by adjusting one or both flow rates or preferably by applying a pump pressure to force the hydrophobic liquid into the aqueous liquid. The method thus allows for a continuous emulsion formation.

Such a continuous emulsion formation has particular application in emulsion polymerization processes. Once a hydrophobic monomer or mixture of monomers has been degassed in accordance with the invention, the actual monomer droplet dispersion could easily be formed simply by increasing the hydrostatic pressure on the hydrophobic liquid to force flow through the pores into the degassed aqueous phase. This dispersion, flowing continuously out from the hollow fibre unit, could then be heat polymerized simply be passing the dispersion through a (possibly rotating to prevent settling) reaction tube at, say, 60° C. for several hours to polymerize the monomer droplets. This process allows for the continuous formation of latex solutions.

The invention will now be described with reference to the following examples which are incorporated for the purpose of illustrating certain features and embodiments of the invention and are not intended to limit the generality hereinbefore described.

### EXAMPLES

### Methods and Materials

Water was prepared by activated charcoal and reverse osmosis filtration prior to distillation and storage in Pyrex vessels in a laminar flow filtered air cabinet. Dodecane was purchased as 99.9% purity and used as supplied. Wherever possible liquids and equipment were handled in a laminar flow cabinet to reduce airborne contamination. The Teflon® hollow-fibre cartridges were small MiniModule units supplied by Membrana, Charlotte, USA. The hollow fibres had an internal diameter of 220 μm and pores of 0.03-0.05 μm. Typically, the units contained between 2000-7000 fibres of 140 mm active length. The InPro 6900 dissolved oxygen electrode system was supplied by Mettler-Toledo Limited, Melbourne, Australia. This system had a high accuracy (˜1%) and detection limit down to 1 ppb and could measure dissolved oxygen levels in water, air and liquid solvents. The vacuum pump used to evacuate the outer chamber of the hollow-fibre unit was an Alcatel diaphragm pump rated at 9 millibars. Conductivity measurements were obtained using a Radiometer CDM 210 with CDC866T four pole probe. Turbidity measurements were obtained using a HF-Micro 100 unit supplied by HF Scientific, Florida, USA. The Atomic Force Microscope (AFM) study was carried out using a Nanoscope IIIa supplied by Digital Instruments (Veeco), in Santa Barbara, USA. Tapping mode analysis was carried out using NT-MDT cantilevers. All images were produced in air.

Contact angle measurements were carried out manually using a microscope and protractor system to image a sessile droplet on a flat plate substrate housed in a sealed glass cell. This system gave a typical contact angle accuracy of about 1-2°. The Teflon® substrates were obtained by manually polishing the rough surface with finely powdered Teflon® for long periods of time. The polypropylene surfaces were prepared by melting the plastic against a smooth glass slide in a nitrogen gas environment.

In the dispersion experiments, mixtures of oil in water was usually achieved by vigorous shaking of the mixture for 8-10 sec in a sealed Pyrex tube. All of the oil and water dispersions experiments were carried out on liquid samples which came from the hollow fibre system, so that any contamination should not affect the comparative validity of these results. The ‘blank’ samples used water and oil collected from the hollow fibre cartridges whilst the vacuum was not running. The non-degassed blank oil and water mixtures were simply shaken. Whilst the freeze-thaw degassed samples were degassed for four freeze cycles, then shaken for ten seconds and recorded. In the freeze-thaw process liquid nitrogen was used to freeze the oil and water mixtures, followed by pumping down to a pressure of 0.01 mbar. Any dissolved gas produced on each melting cycle was removed upon re-freezing and pumping. Typically, no further bubbling, on melting, was observed after 3-4 cycles. The vacuum pressure of 0.01 mbar corresponds to a degassing level of about 99.999%, if it is assumed that the final pressure achieved after several cycles of freeze/thaw/pumping is given by the pressure in equilibrium with the final frozen liquid, which on being melted does not give any visible bubbling or out-gassing.

The hollow fibre degassed samples used both oil and water degassed by the cartridges. The oil (0.2 ml dodecane) was syringed into a tube which was then evacuated. This vacuum was then used to suck the (degassed) water (25 ml) into the tube. The tube was then quickly evacuated again. As soon as the liquids were observed bumping (2-3 seconds after opening the vacuum tap) the tube was closed, the mixture was shaken for 10 seconds and the turbidity recorded over time.

### Example 1

### Contact Angle Measurements

The results for the AFM study of the surface roughness of polypropylene and Teflon® surfaces (using tapping mode) show that the rms roughness value for each substrate was 1.8 nm for polypropylene and 52 nm for Teflon®. The polypropylene melted surface was clearly much smoother than the polished Teflon®. However, in both cases a 1:1 image showed a featureless image of slightly undulating hills and valleys.

From the various interfacial tensions, the Young equation for the contact angle θ is given by:

γ_{ap/ss}=γ_{ap/d} cos θ+γ_{ss/d}

where γ_{ap/ss}, γ_{ap/d} and γ_{ss/d} are the interfacial tensions for the ambient phase/solid substrate, ambient phase/droplet and solid substrate/droplet, respectively.

It follows that water droplets on Teflon® and polypropylene immersed in air, should have a very high contact angle, as is demonstrated by the results given in Table 1 & 2. The relatively low contact angle hysteresis observed for the polished Teflon® substrates and the melted polypropylene substrate indicates that both surfaces were reasonably smooth and clean. By comparison, the results obtained for water droplets immersed in dodecane, on both polypropylene and Teflon®, are remarkable because in both cases the angle observed was close to 180°, with no apparent hysteresis. In both cases the droplets readily roll off the substrate, when tilted even a few degrees.

TABLE 1
Solid Substrate: Polypropylene

| | | Contact Angle | Contact Angle |
|---|---|---|---|
| Droplet | Ambient Phase | Advancing | Receding |
| PFH | Air | <10 | <10 |
| PFH | Water | 78 | 32 |
| Water | Air | 120 | 80 |
| Dodecane | Air | 10 | 10 |
| TCE | Air | 12 | 0 |
| TCE | Water | 35 | 0 |
| Water | Dodecane | 180 | 180 |

TABLE 2
Solid Substrate: Teflon ®

| | | Contact angle | Contact angle |
|---|---|---|---|
| Droplet | Ambient Phase | advancing | receding |
| PFH | Air | 10 | 10 |
| PFH | Water | 90 | 21 |
| Water | Air | 116 | 95 |
| Dodecane | Air | 38 | 17 |
| TCE | Air | 55 | 30 |
| TCE | Water | 95 | <10 |
| Water | Dodecane | 180 | 180 |

These observations for polypropylene substrates are consistent with the Young equation because for the case of water droplets immersed in dodecane, the ambient phase is chemically similar to the solid substrate. Hence, it is expected that γ_{ap/ss} will be close to zero and since γ_{ap/d}≈γ_{ss/d}, it follows that cos θ [symbol] −1 and hence θ [symbol] 180°.

However, a similar situation was also observed for water droplets on Teflon® immersed in dodecane. In this case it is expected that the interfacial tension between the droplet and the ambient phase should be about 53 mJm⁻² (i.e. water/dodecane (Goebel, A. and Lunkenheimer, K., Langmuir 13:369-372 (1997)) and between the droplet and solid substrate about 43 mJm⁻² (i.e. water and Teflon®). This latter value was calculated from the critical surface tension for Teflon® of 18 mJm⁻² and the water droplet contact angle on Teflon®, of 110°, using the Young equation (Shaw, D. J., Introduction to Colloid and Surface Chemistry, Butterworths, 3^{rd} ed, 1985). A small interfacial tension between the ambient phase and the solid substrate would therefore produce a high contact angle, of about 140° according to the Young equation but not the 180° value observed. It is possible that dodecane penetrates or is retained in some way by the Teflon® surface, and hence the droplet is actually advancing over essentially a dodecane surface.

The measured contact angles reported in Tables 1 & 2 can be used to predict the ability of vacuum degassing or counter-flow de-gassing to de-gas hydrophobic liquids. For example, the high contact angle (>90°) observed for water on polypropylene and Teflon surfaces in air, shows that vacuum degassing of water is possible with either membrane material. By comparison, the results in Table 1 indicate that perfluorohexane (PFH), dodecane (DD) and tetrachloroethylene (TCE) cannot be degassed using polypropylene membranes because these liquids will readily flow through the pores, drawn by the vacuum. However, the contact angles of water droplets on polypropylene, immersed in several non-aqueous liquids, indicates that the use of the counter-flow process, with degassed water as the gas absorbent, will allow retention of the non-aqueous liquid (PFH, DD and TCE), with the application of a modest hydrostatic pressure. As an example, PFH should be retained by water with an applied pressure of about 0.4 bars, for a micron-sized polypropylene membrane.

Similar results obtained using polished Teflon® substrates also indicate that this material can be used in a counter-flow process with degassed water to remove gases from PFH, DD and TCE. As an example, TCE should be retained by water by the application of a modest differential pressure of about 0.14 bar.

FIG. 2 illustrates Laplace pressures calculated for water/dodecane and water/tetrachloroethylene in Teflon® pores.

### Example 2

### Degassing of a Hydrophobic Liquid Phase

A schematic diagram of the hollow-fibre unit used in these experiments is given in FIG. 3. Using the Teflon® hollow-fibre MiniModule unit at a water flow rate of about 140 ml per minute, a degassing level of typically about 99.6% was obtained, corresponding to about 33 ppb dissolved oxygen. The pH value of this water increased from 5.8 to 7.0-7.1, due to the removal of dissolved carbon dioxide. When this water was used as the outer fluid in a second hollow-fibre unit, with gassed dodecane inside the fibres flowing in the opposite direction, a degassing rate of typically about 99.2% was observed for dodecane, in a single pass process (i.e. 65 ppb dissolved oxygen). These results demonstrate that the process, even in a single stage, efficiently removes dissolved gases from non-aqueous liquids to a high degree. The dodecane flow rate used in these MiniModules was relatively low, at about 2 ml/min. However, this rate could obviously be substantially increased using larger units. The higher flow rate (140 ml/min) counter-flow of de-gassed water was continuously recycled through the first HF vacuum membrane system, during the process, to improve efficiency and save water. This recycled, degassed water remained completely clear during the exchange process, which shows that the dodecane was completely retained inside the HF exchange membrane during the process. The efficiency of the exchange process could, of course, be further improved by using a higher capacity vacuum pumping system, to de-gas the feed water to a higher degree.

### Example 3

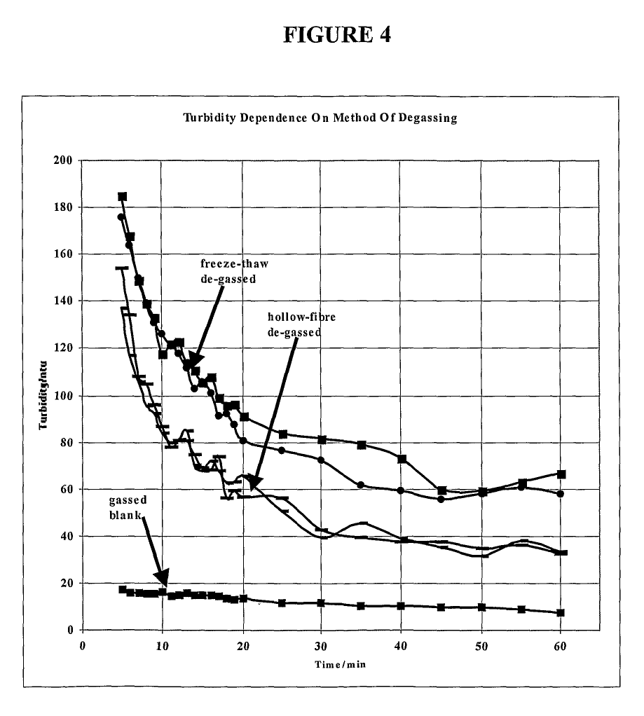

Water and dodecane de-gassed by the HF membrane process were mixed and shaken and their dispersion compared with the gassed case and mixtures degassed by the freeze-thaw technique. The results are depicted in FIG. 4. The results obtained clearly demonstrate that degassing dodecane and water separately, using the novel membrane system, is sufficient to cause enhanced dispersion, significantly above that for gassed, ‘blank’ mixtures.

### BIBLIOGRAPHY

Goebel, A. and Lunkenheimer, K., Langmuir 13:369-372 (1997).
Shaw, D. J., Introduction to Colloid and Surface Chemistry, Butterworths, 3^{rd} ed, 1985.

1. A method for degassing a hydrophobic liquid containing dissolved gas, comprising passing the hydrophobic liquid along one side of a porous hydrophobic membrane and simultaneously passing a degassed aqueous liquid along the other side of the membrane, such that at least a portion of the gas dissolved in the hydrophobic liquid is transferred to the aqueous liquid.

2. The method according to claim 1 wherein the hydrophobic membrane is a polytetrafluoroethylene or polypropylene membrane.

3. The method of claim 1, wherein the membrane has a pore radius in the range of 0.1 mm to 0.01 μm.

4. The method of claim 1, wherein at least 80% of the gas dissolved in the hydrophobic liquid is transferred to the aqueous liquid.

5. The method according to claim 4 wherein at least 95% of the gas dissolved in the hydrophobic liquid is transferred to the aqueous liquid.

6. The method according to claim 5 wherein at least 99% of the gas dissolved in the hydrophobic liquid is transferred to the aqueous liquid.

7. The method of claim 1, wherein the membrane is in the form of a hollow fibre filter unit.

8. The method according to claim 7 where a plurality of hollow fibre filter units are connected in series.

9. The method of claim 1, wherein the degassed aqueous phase used has an oxygen concentration of 100 ppb or less.

10. The method of claim 1, wherein the hydrophobic liquid is a hydrocarbon or halocarbon.

11. A degassed hydrophobic liquid obtained by the method according to claim 1 having an oxygen concentration of 100 ppb or less.

12. A method for preparing an emulsion of a hydrophobic liquid and an aqueous liquid comprising:
(i) degassing a hydrophobic liquid containing dissolved gas, comprising passing the hydrophobic liquid along one side of a porous hydrophobic membrane and simultaneously passing a degassed aqueous liquid along the other side of the membrane, such that at least a portion of the gas dissolved in the hydrophobic liquid is transferred to the aqueous liquid;
(ii) combining said degassed hydrophobic liquid with a degassed aqueous liquid to form an emulsion.

13. A method according to claim 12 wherein the degassed hydrophobic liquid and degassed aqueous liquid of (ii) are shaken or agitated together to form an emulsion.

14. The method of claim 12, wherein the emulsion is formed without the addition of stabilizers, surfactants or dispersants.

15. The method of claim 12, wherein the emulsion is formed in situ by allowing the degassed hydrophobic liquid to pass through the membrane and disperse into a degassed aqueous phase.

16. The method of claim 1, wherein the hydrophobic liquid is a monomer, or mixture of monomers, optionally together with a radical initiator.

17. The method according to claim 16 wherein a monomer is one selected from styrene, pentafluorostyrene, octafluorostyrene, octafluoropentyl acrylate and hexafluorobutyl methacrylate.

18. The method of claim 16, wherein the initiator is azobisisobutyronitrile or a benzoin ether.

19. The method of claim 14, wherein the emulsion is formed in situ by allowing the degassed hydrophobic liquid to pass through the membrane and disperse into a degassed aqueous phase.

20. The method of claim 11, wherein the hydrophobic liquid is a monomer, or mixture of monomers, optionally together with a radical initiator.

21. The method of claim 12, wherein the hydrophobic liquid is a monomer, or mixture of monomers, optionally together with a radical initiator.

22. The method of claim 17, wherein the initiator is azobisisobutyronitrile or a benzoin ether.
